(19) United States
(12) Patent Application Publication
(10) Pub. No.: US 2021/0181316 A1
(43) Pub. Date: Jun. 17, 2021

(54) TIME-OF-FLIGHT-BASED DISTANCE MEASUREMENT SYSTEM AND METHOD

(71) Applicant: ORADAR TECHNOLOGY COMPANY LIMITED, Shenzhen (CN)

(72) Inventors: Liang ZHU, SHENZHEN (CN); Zhi CHEN, SHENZHEN (CN); Min YAN, SHENZHEN (CN)

(21) Appl. No.: 17/184,390

(22) Filed: Feb. 24, 2021

Related U.S. Application Data
(63) Continuation of application No. PCT/CN2019/103735, filed on Aug. 30, 2019.

(51) Int. Cl. G01S 7/4865

(52) U.S. Cl. CPC G01S 7/4865; G01S 7/4863

(57) ABSTRACT

A time of flight (TOF)-based distance measurement system and method with a time code are provided. The system includes: an emitter, configured to emit an optical signal pulse train with a time code; a collector, configured to collect photons in the optical signal pulse train reflected by an object; and a processing circuit, connected to the emitter and the collector, and configured to count the photons to form a frame-period single-photon counting timing train, and draw a histogram based on the time code and the frame-period single-photon counting timing train. In the system and method of this application, the emitter is allowed to emit a pulse train based on a pulse period far shorter than a maximum TOF corresponding to a maximum measurement distance, so that a frame rate may be improved significantly.

### CROSS-REFERENCE TO RELATED APPLICATIONS

This application is a continuation application of International Patent Application No. PCT/CN2019/103735, filed on Aug. 30, 2019, entitled “TIME-OF-FLIGHT-BASED DISTANCE MEASUREMENT SYSTEM AND METHOD.” The contents of the above-identified application is incorporated herein by reference in its entirety.

### TECHNICAL FIELD

This application relates to the field of computer technologies, and in particular, to a time of flight (TOF)-based distance measurement system and method with a time code.

### BACKGROUND

The TOF method calculates a distance to an object by measuring a TOF of a beam in space. Due to advantages such as high precision and large measurement distance, the method is widely used in fields such as consumer electronics, autonomous vehicles, and AR/VR.

A distance measurement system based on the TOF principle, such as a TOF depth camera or a lidar, usually includes a light source serving as an emitting end and a receiving end. The light source emits a beam to a target space for illumination, the receiving end receives the beam reflected by a target, and the system calculates a distance to an object by calculating a time required for the beam to be emitted and to be received after being reflected. When a direct TOF method is used to perform measurement, the emitting end emits a pulsed beam to a target. The pulsed beam is emitted at a certain frequency, and a time interval (pulse period) between adjacent pulses is required to be not less than a maximum TOF corresponding to a maximum measurement distance of the system, to avoid a sign recognition failure. Therefore, a frame rate of the system is usually limited by the maximum measurement distance. When the measurement distance of the system reaches one hundred meters or more, the frame rate is extremely low, making it difficult to meet some practical application's requirement for a high frame rate.

In addition, when a plurality of systems work synchronously in the same space, interference easily occurs, that is, a receiving end of a system not only receives a light signal emitted by an emitting end of the system, but also receives a light signal emitted by an emitting end of another system. As a result, an error is caused.

The foregoing content disclosed in BACKGROUND is only used to assist in understanding the concepts and technical solutions of this application. In the absence of clear evidence that the foregoing content has been disclosed on the filing date of this application, BACKGROUND should not be used to evaluate novelty and inventiveness of this application.

### SUMMARY

To resolve at least one of a problem that the frame rate of the system is limited by a maximum measurement distance and a problem of interference between a plurality of machines, this application provides a TOF-based distance measurement system and method with a time code.

A TOF-based distance measurement system includes:

an emitter, configured to emit an optical signal pulse train with a time code;

a collector, configured to collect photons in the optical signal pulse train reflected by an object; and

a processing circuit, connected to the emitter and the collector, and configured to count the photons to form a frame-period single-photon counting timing train, and draw a histogram based on the time code and the frame-period single-photon counting timing train.

Further, the processing circuit is configured to determine a time corresponding to a pulse waveform in the histogram; and determine a TOF according to the time corresponding to the pulse waveform.

Further, a time interval between adjacent pulse trains is less than a maximum TOF corresponding to a maximum measurement distance.

Further, the collector includes a single-photon avalanche photodiode (SPAD).

Further, the time code is a regular time code [Δt, 2Δt, 3Δt, . . . , (n−1)Δt], where Δt is a pulse period, and n is a quantity of pulses included in the optical signal pulse train; and the histogram is drawn in the following manner: using a time unit in the histogram as a start unit, accumulating photon counts in all time units subsequently spaced from the start unit by an integral quantity of Δt in the timing train and a photon count in the start unit, and using an accumulated photon count as a photon count value of the start unit.

Further, the histogram is drawn starting from a middle time unit of the frame-period single-photon counting timing train, and the processing circuit is configured to search for a pulse waveform, and in response to that a pulse waveform is found, to draw the histogram in a direction to an earlier time unit until no pulse waveform is found in an earlier time period spaced from the current pulse waveform by Δt.

Further, the time code is a random time code [Δt1, Δt1+Δt2, Δt1+Δt2+Δt3, . . . , Δt1+Δt2 . . . +Δt(n−1)], and Δti represents a time interval between an ith pulse and an (i+1)th pulse, where i=1,2, . . . (n−1), and n is a quantity of pulses in the optical signal pulse train; and the histogram is drawn in the following manner: using a time unit in the histogram as a start unit, accumulating photon counts in all time units subsequently spaced from the start unit by Δt1, Δt1+Δt2, Δt1+Δt2+Δt3, . . . , and Δt1+Δt2 . . . +Δt(n−1) in the timing train and a photon count in the start unit, and using an accumulated photon count as a photon count value of the start unit.

Further, the histogram is drawn starting from a middle time unit of the frame-period single-photon counting timing train, and the processing circuit is configured to search for a pulse waveform, and in response to that a pulse waveform is found, to determine a TOF according to a time corresponding to the found pulse waveform.

Further, a time length of the histogram is [(n−1)·Δt+t1], or the time length of the histogram is t1, where t1 is a maximum TOF corresponding to the maximum measurement distance.

Further, a length of a minimum time unit of the histogram is integer times of that in each time unit in the frame-period single-photon counting timing train.

Further, when the histogram is drawn, for the frame-period single-photon counting timing train, a time-code-based accumulation is performed at an interval of one or more time units.

Further, a threshold is set to search for a pulse waveform in the histogram, where a value of the pulse waveform higher than the threshold is retained, and a value of the pulse waveform less than the threshold is discarded as a noise.

Further, a total time length of the drawn histogram is adaptively changed based on a search algorithm execution process.

A TOF-based distance measurement method with includes the following steps:

emitting an optical signal pulse train with a time code;

collecting photons in the optical signal pulse train reflected by an object;

counting the photons to form a frame-period single-photon counting timing train; and

drawing a histogram based on the time code and the frame-period single-photon counting timing train.

Further, the method further includes:

determining a time corresponding to a pulse waveform in the histogram; and

determining a TOF according to the time corresponding to the pulse waveform.

Further, a time interval between adjacent pulse trains is less than a maximum TOF corresponding to a set maximum measurement distance.

Further, the photons are collected by a SPAD.

Further, the time code is a regular time code [Δt, 2Δt, 3Δt, . . . , (n−1)Δt], where Δt is a pulse period, and n is a quantity of pulses included in the optical signal pulse train; and drawing the histogram comprises: using a time unit in the histogram as a start unit, accumulating photon counts in all time units subsequently spaced from the start unit by an integral quantity of Δt in the timing train and a photon count in the start unit, and using an accumulated photon count as a photon count value of the start unit.

Further, drawing the histogram comprises drawing the histogram starting from a middle time unit of the frame-period single-photon counting timing train, searching for a pulse waveform, and in response to that a pulse waveform is found, drawing the histogram continues in a direction to an earlier time unit until no pulse waveform is found in an earlier time period spaced from the current pulse waveform by Δt.

Further, the time code is a random time code [Δt1, Δt1+Δt2, Δt1+Δt2+Δt3, . . . , Δt1+Δt2 . . . +Δt(n−1)], and Δti represents a time interval between an ith pulse and an (i+1)th pulse, where i=1,2, . . . (n−1), and n is a quantity of pulses in the optical signal pulse train; and the histogram is drawn in the following manner: using a time unit in the histogram as a start unit, accumulating photon counts in all time units subsequently spaced from the start unit by Δt1, Δt1+Δt2, Δt1+Δt2+Δt3, . . . , and Δt1+Δt2 . . . +Δt(n−1) in the timing train and a photon count in the start unit, and using an accumulated photon count as a photon count value of the start unit.

Further, drawing histogram comprises starting from a middle time unit of the frame-period single-photon counting timing train, searching for a pulse waveform, and in response to that a pulse waveform is found, determining a according to a time corresponding to the found pulse waveform.

Further, a time length of the histogram is [(n−1)·Δt+t1], or the time length of the histogram is t1, where t1 is a maximum TOF corresponding to a maximum measurement distance.

Further, a length of a minimum time unit of the histogram is integer times of that in each time unit in the frame-period single-photon counting timing train.

Further, drawing the histogram, for the frame-period single-photon counting timing train, comprises performing a time-code-based accumulation at an interval of one or more time units.

Further, a threshold is set to search for a pulse waveform in the histogram, where a value of the pulse waveform higher than the threshold is retained, and a value of the pulse waveform less than the threshold is discarded as a noise.

Further, a total time length of the drawn histogram is adaptively changed based on a search algorithm execution process.

This application has the following beneficial effects:

This application provides a TOF-based distance measurement system and method with a time code. In this application, an emitter is allowed to emit a pulse train based on a pulse period far shorter than a maximum TOF corresponding to a maximum measurement distance, so that a frame rate may be improved significantly. Further, an embodiment of this application further provides a TOF-based distance measurement method with a time code that can prevent interference.

### BRIEF DESCRIPTION OF THE DRAWINGS

FIG. 1 is a schematic diagram of a TOF-based distance measurement system, according to an embodiment of this application.

FIG. 2(a) is a schematic diagram showing that a corresponding time code is a regular time code, and an emitter emits a pulse train including n pulses based on a pulse period Δt, according to an embodiment of this application.

FIG. 2(b) is a schematic diagram showing that a corresponding time code is a regular time code, and after a time of t, a collector receives photons in a pulse train reflected by a target, according to an embodiment of this application.

FIG. 3(a) is a schematic diagram of a frame-period single-photon counting timing train with a regular time code, according to an embodiment of this application.

FIG. 3(b) is a histogram formed after accumulation based on a regular time code, according to an embodiment of this application.

FIG. 4(a) is a schematic diagram showing that a corresponding time code is a random time code, and an emitter emits a pulse train including n pulses at a random time interval, according to an embodiment of this application.

FIG. 4(b) is a schematic diagram showing that a corresponding time code is a random time code, and after a time of t, a collector receives photons in a pulse train reflected by a target, according to an embodiment of this application.

FIG. 5(a) is a schematic diagram of a frame-period single-photon counting timing train with a random time code, according to an embodiment of this application.

FIG. 5(b) is a histogram formed after accumulation based on a random time code, according to an embodiment of this application.

FIG. 6(a) is a schematic diagram showing that a corresponding time code is a dual random time code, and an emitter emits N*n pulses at a dual random time interval, according to an embodiment of this application.

FIG. 6(b) is a schematic diagram showing that a corresponding time code is a dual random time code, and after a time of t, a collector receives photons in a pulse train reflected by a target, according to an embodiment of this application.

FIG. 7(a) is a schematic diagram of N pulse group period single-photon counting timing trains with a dual random time code, according to an embodiment of this application.

FIG. 7(b) is a histogram formed after accumulation based on a dual random time code, according to an embodiment of this application.

FIG. 8 is a schematic diagram of a time-code-based demodulation processing circuit, according to an embodiment of the present invention.

FIG. 9 is a schematic diagram of another time-code-based demodulation processing circuit, according to an embodiment of the present invention.

### DETAILED DESCRIPTION

To make the technical problems to be resolved by embodiments of this application, and the technical solutions and beneficial effects of the embodiments of this application clearer and more comprehensible, the following further describes this application in detail with reference to the accompanying drawings and embodiments. It should be understood that the specific embodiments described herein are merely used to explain this application but are not intended to limit this application.

It should be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by the terms such as “length,” “width,” “above,” “below,” “front,” “back,” “left,” “right,” “vertical,” “horizontal” “top,” “bottom,” “inside,” and “outside” are based on orientation or position relationships shown in the accompanying drawings, and are used only for ease and brevity of illustration and description of the embodiments of this application, rather than indicating or implying that the mentioned apparatus or element needs to have a particular orientation or needs to be constructed and operated in a particular orientation. Therefore, such terms should not be construed as limiting this application.

In addition, terms “first” and “second” are only used for describing the objective and cannot be understood as indicating or implying relative importance or implying a quantity of the indicated technical features. In view of this, a feature defined by “first” or “second” may explicitly or implicitly include one or more features. In the descriptions of the embodiments of this application, unless otherwise specified, “a plurality of” means two or more.

TOF-Based Distance Measurement System

This application provides a TOF-based distance measurement system, which has a stronger ambient light immunity capability and a higher resolution.

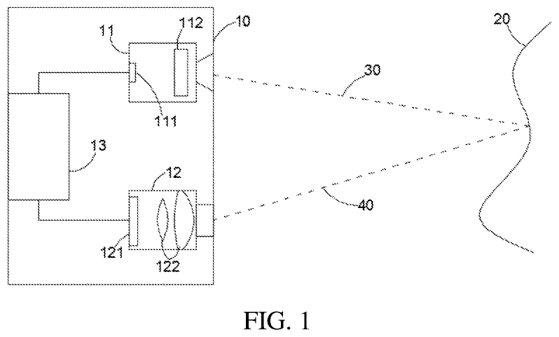

FIG. 1 is a schematic diagram of a TOF-based distance measurement system, according to an embodiment of this application. The distance measurement system 10 includes an emitter 11, a collector 12, and a processing circuit 13. The emitter 11 provides an emitted beam 30 to a target space to illuminate an object 20 in the space. At least a portion of the emitted beam 30 is reflected by the object 20 to form a reflected beam 40, and at least a portion of optical signals (photons) of the reflected beam 40 are collected by the collector 12. The processing circuit 13 is connected to the emitter 11 and the collector 12. Trigger signals of the emitter 11 and the collector 12 are synchronized to calculate a time required for the beam to be emitted by the emitter 11 and received by the collector 12, that is, a TOF t between the emitted beam 30 and the reflected beam 40. Further, a distance D to a corresponding point on the object can be calculated by the following formula:

D=c·t/2 (1)

where c is a speed of light.

The emitter 11 includes a light source 111 and an optical element 112. The light source 111 may be a light source such as a light emitting diode (LED), an edge emitting laser (EEL), a vertical cavity surface emitting laser (VCSEL), or may be an array light source including a plurality of light sources. In some embodiments, the array light source 111 may be a VCSEL array light source chip formed by forming a plurality of VCSEL light sources on a single semiconductor substrate. A beam emitted by the light source 111 may be visible light, infrared light, ultraviolet light, or the like. The light source 111 emits a beam under the control of the processing circuit 13. For example, in an embodiment, the light source 111 emits a pulsed beam at a certain frequency (pulse period) under the control of the processing circuit 13, which can be used in a direct TOF measurement method with a certain frequency set according to a to-be-measured distance, for example, it can be set to 1 MHz to 100 MHz. The to-be-measured distance ranges from several meters to several hundred meters. The light source 111 may be controlled to emit related beams by a portion of the processing circuit 13 or a sub-circuit independent of the processing circuit 13, such as a pulse signal generator.

The optical element 112 receives the pulsed beam from the light source 111, performs optical modulation such as diffraction, refraction, or reflection on the pulsed beam, and emits a modulated beam such as a focused beam, a flood beam, or a structured light beam into the space. The optical element 112 may be a lens, a diffractive optical element, a mask, a reflector, or may be in a form such as a MEMS scanning mirror.

The processing circuit 13 may be an independent dedicated circuit, such as a dedicated SOC chip, FPGA chip, or ASIC chip, or may include a general-purpose processor. For example, when a depth camera is integrated into a smart terminal such as a mobile phone, a television, or a computer, a processor in the terminal may be used as at least a portion of the processing circuit 13.

The collector 12 includes a pixel unit 121 and an imaging lens unit 122. The imaging lens unit 122 receives at least a portion of the modulated beam reflected by the object and guides the portion to the pixel unit 121. In an embodiment, the pixel unit 121 includes a SPAD, or may be an array pixel unit including a plurality of SPAD pixels. An array size of the array pixel unit represents a resolution of the depth camera, such as 320×240. The SPAD can respond to a single input photon to detect the single photon, which can achieve long-distance and high-precision measurement due to high sensitivity and fast response speed. Compared with an image sensor including a CCD/CMOS and based on the principle of light integration, the SPAD can collect a weak light signal and calculate a TOF by counting single photons, for example, using a time-correlated single-photon counting (TCSPC) method. Generally, a read circuit (not shown in the figure) is further connected to the pixel unit 121, and includes one or more of devices such as a signal amplifier, a time-to-digital converter (TDC), and an analog-to-digital converter (ADC). The circuit may be integrated with the pixel unit, or may be a portion of the processing circuit 13. For ease of description, the circuit is considered as a portion of the processing circuit 13 in the embodiments of this application.

In some embodiments, the distance measurement system 10 may further include devices such as a color camera, an infrared camera, and an IMU. Combination with such devices can achieve more functions, such as 3D texture modeling, infrared face recognition, and SLAM.

In some embodiments, the emitter 11 and the collector 12 may be disposed in a coaxial form, that is, the two are implemented by an optical device with reflection and transmission functions, such as a half mirror.

In the direct-TOF-based distance measurement system using a SPAD, a single photon input to the SPAD pixel may cause an avalanche. The SPAD outputs an avalanche signal to a TDC circuit, and the TDC circuit detects a time interval between the photon is emitted from the emitter 11 and the avalanche is caused. After a plurality of detections, a histogram statistics collection is performed on time intervals by using a TCSPC circuit to restore a waveform of an entire pulse signal, so as to precisely detect a TOF. Finally, distance information of the object is calculated according to the TOF. Assuming that a pulse period of emitting the pulsed beam is Δt and a maximum measurement distance of the distance measurement system is D max, a corresponding maximum TOF is

$${t}_{1} = \frac{2 D max}{c} .$$

Generally, Δt≥t1 is required to avoid signal confusion, where c is a speed of light. If a quantity of detections required by TCSPC is n, a time (frame period) for a single distance measurement is not less than n*t1. For example, the maximum measurement distance is 150 m, and a corresponding pulse period Δt=1 us, and n=100000. Then, the frame period is not less than 100 ms, and a frame rate is less than 10 fps. As such, the maximum measurement distance in the TCSPC method may limit the pulse period, thereby affecting the frame rate of distance measurement.

To resolve this problem, according to the following embodiments, the TOF-based distance measurement system and method with a time code provided in this application may be implemented by using several different time-code-based pulse modulation and demodulation solutions. Descriptions are as follows.

Regular Time-Code-Based Pulse Modulation and Demodulation Method

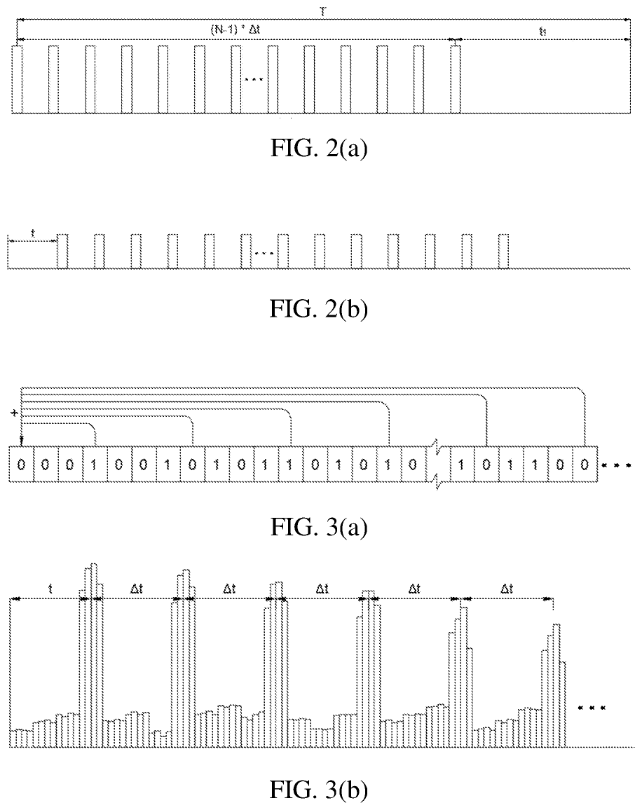

FIG. 2(a) and FIG. 2(b) are schematic diagrams of time-code-based pulse modulation, according to an embodiment of this application. The emitter 11 emits a pulse train based on a pulse period Δt that is far less than a maximum TOF

$${t}_{1} = \frac{2 D max}{c}$$

corresponding to a maximum measurement distance D max, where the pulse train includes n pulses, as shown in FIG. 2(a). If a to-be-detected target is at a position D, and a corresponding TOF is t, the collector 12 will successively receive, after the time of t, photons in the pulse train reflected by the target, as shown in FIG. 2(b). To avoid mutual interference between pulsed beams in two adjacent frame periods, a frame period T is set to T≥(n−1)·Δt+t1. That is, when the target is located at a maximum measurement distance, a time required from the emitter 11 emitting the last pulse in the pulse train to the collector 12 receiving the last pulse is exactly t1. In this way, it is ensured that all pulses in a single frame period are received and not affected by pulses in an adjacent frame period. In an embodiment, assuming that the maximum measurement distance D max=150 m, and n=100000, but the pulse period Δt=100 ns, which is far less than 1 us in the foregoing embodiment, the frame period T is about 10 ms, and the frame rate reaches 100 fps.

It should be understood that the waveform of each pulse in the emitted pulse train is usually not as regular as the rectangular wave shown in the figure, wherein the waveform and the received pulse train are examples. In practice, the pulse train received by the collector 12 is a sequence that may reflect a quantity of photons of the received pulse train, which is described below in detail.

The conventional TCSPC method is not applicable to calculate a distance at such a high frame rate. Therefore, this application provides a brand-new time-code-based consecutive single-photon counting demodulation method.

FIG. 3(a) and FIG. 3(b) show a time-code-based consecutive single-photon counting demodulation method, according to an embodiment of this application. When the emitter 11 emits a pulse train including n pulses, the collector 12 is activated to collect a portion of photons in the pulses reflected by a target. The processing circuit 13 processes and records a corresponding incident time of each incident photon. For example, the processing circuit 13 collects incident photon time by using a TDC circuit. Subsequently, the processing circuit recognizes and records the photon time, to finally form the frame-period single-photon counting timing train shown in FIG. 3(a). Each block of the timing train is a minimum time unit decided by a time resolution of the TDC. When the TDC detects a photon event within a time of the minimum time unit, the photon event is recorded (for example, a photon count 1 in the figure represents that a photon is detected within the minimum time unit). A value in each block is a photon count (0 or 1), and a total time length of the timing train may be equal to a frame period. The timing train may be obtained and stored in an internal memory in any appropriate manner. For example, the timing train is obtained by a TDC with a relatively high bandwidth through continuous collection, or may be obtained by a TDC with a relatively low bandwidth through splicing after a plurality of times of collection.

In an embodiment, the frame-period single-photon counting timing train may be collected by using another type of circuit. For example, a sampling circuit may respond to an avalanche signal of the SPAD to directly obtain the timing train. Therefore, the frame-period single-photon counting timing train may also be referred to as a frame-period single-photon sampling timing train.

In an embodiment, the collected frame-period single-photon counting timing train is stored in the internal memory. Subsequently, a histogram circuit in the processing circuit 13 draws a histogram based on the timing train, which is different from the histogram drawing principle in the conventional TCSPC. The histogram in this embodiment is drawn through time-code-based consecutive single-photon counting accumulation. In an embodiment, a minimum time unit (a minimum storage unit bin) of the histogram is the same as that of the timing train. For the to-be-drawn time units, accumulation, for example, sequential accumulation, is performed according to a time code emitted with the pulse train. The pulse train is emitted based on a pulse period Δt and includes n pulses in total, and a corresponding time code is a regular time code, that is, [Δt, 2Δt, 3Δt, . . . (n−1)Δt]. Accumulation based on the time code refers to, using a current to-be-drawn time unit as a start unit, sequentially accumulating photon counts in all time units subsequently spaced from the start unit by Δt, 2Δt, 3Δt, . . . (n−1)Δt in the timing train and a photon count in the start unit, and using an accumulated photon count as a value of each time unit in the histogram. For example, an accumulation manner of the first time unit in the histogram is shown by the arrow in FIG. 3(a). A histogram formed by performing time-code-based accumulation on a plurality of time units is shown in FIG. 3(b).

Due to different distances and reflectivity of the target, there may be only a few photons in each pulse entering the collector 12, and an avalanche is generated at a certain probability, thereby causing a single-photon counting event. In terms of statistical probability, a probability that the collector 12 collects the photon counting event is the highest only at a moment at which all the pulses in the pulse train emitted by the emitter 11 are reflected by the target to the collector 12 in the entire frame period. In other words, a probability that photons are collected is the highest at a moment at which the pulse train is received as shown in FIG. 2(b), which means that a probability of a corresponding time unit with the photon count “1” in the timing train in FIG. 3(a) is higher than those of other time units. Therefore, after time-code-based histogram accumulation is performed, wave peaks, that is, largest quantities of collected photons, occur within times of t+(Δt, 2Δt, 3Δt, . . . , (n−1)Δt). In addition, because the accumulation is sequentially performed, values of the wave peaks are gradually reduced as time goes on. However, a TOF t of the target can be calculated provided that a time within which the first pulse wave peak is located.

Generally, a time resolution of the TDC is less than a pulse width. In other words, a width of each time unit of the timing train is less than the pulse width. After the time-code-based consecutive single-photon counting accumulation is performed, it may be seen from the obtained histogram that a plurality of time units have relatively large values, and a waveform graph indicating a pulse shape is formed. In this case, a time corresponding to the highest point of the waveform graph is used as a to-be-measured TOF.

When the frame period T>(n−1)·Δt+t1, a collection time of photons does not need to cover the entire frame period, and the photons only need to be collected within a time of [(n−1)·Δt+t1], that is, a length of the frame-period single-photon counting timing train is [(n−1)·Δt+t1]. Data processing such as histogram calculation, TOF calculation, and distance calculation may be performed within the remaining time of the frame period.

In an embodiment, when a time-code-based consecutive single-photon counting accumulation histogram is drawn, a length of a minimum time unit of the histogram may be integer times such as twice of that in each time unit in the frame-period single-photon counting timing train. Therefore, the amount of calculation and memory required when the histogram is drawn may be reduced.

In an embodiment, when a time-code-based consecutive single-photon counting accumulation histogram is drawn, an interval between adjacent time units, that is, a step length, may be greater than 1. For example, a time-code-based accumulation is performed at an interval of one time unit. Therefore, the amount of calculation and memory required when the histogram is drawn may also be reduced.

In an embodiment, a total time length of the histogram is [(n−1)·Δt+t1]. When accumulation is performed on time units after a time of t1, no photon count of the time units in the timing train is accumulated. A quantity of time units involved in the accumulation is gradually reduced. In practice, in an embodiment, it is unnecessary to draw a histogram having the same length as that of the frame period, and only a histogram in a time period from 0 to t1 needs to be drawn. Because the first wave peak will certainly occur if the target is located within the maximum measurement distance, the TOF t may be determined based on the first wave peak.

In an embodiment, a threshold may be set to search for a pulse waveform in the histogram. A value higher than the threshold is retained, and a value less than the threshold is considered as noise.

In an embodiment, a drawing order of the histogram may be changed, that is, the time units may not be drawn one by one starting from 0. For example, the drawing may be performed starting from a middle time by using a dichotomy. Once the first pulse waveform is found, the drawing continues to be performed in a direction to an earlier time unit until no waveform is found in an earlier time period spaced from the current pulse waveform by Δt. In this case, it is considered that a time corresponding to the current pulse waveform is the TOF of the target. In conclusion, any appropriate search algorithm that can position the first pulse waveform is applicable to this solution. In this embodiment, the total time length of the histogram is adaptively changed based on an execution process of the search algorithm. Once the first pulse waveform is drawn and detected, the calculation will stop. Subsequently, a wave peak position may be determined by using the first pulse waveform, so as to obtain the TOF t. Generally, the total time length of the adaptive changed histogram does not exceed the maximum TOF t1, so that the calculation amount and memory consumption may be significantly reduced.

Compared with the conventional TCSPC, the brand-new time-code-based consecutive single-photon counting demodulation method shown in FIG. 3(a) and FIG. 3(b) has a higher requirement on memory and a larger calculation amount. However, the benefits are also obvious, that is, the emitter 11 may be allowed to emit pulse trains based on a pulse period far shorter than the maximum TOF corresponding to the maximum measurement distance, so that the frame rate may be improved significantly. In spite of this, the modulation and demodulation method shown in FIG. 2(a) to FIG. 3(b) cannot resolve a problem of interference between a plurality of machines. This application further provides a TOF-based distance measurement method with a time code that can prevent interference.

In some embodiments, a process of drawing a frame-period single-photon counting timing train and a process of drawing a histogram based on the frame-period single-photon counting timing train may be combined into one step, that is, the histogram may be directly drawn based on a photon count. The two steps may also be expanded to more than three steps. The implementation principles are the same, but the implementation forms are different, and corresponding required hardware circuits are also different. For example, an implementation form of combining two steps into one step is described in detail in the following specific processing circuit design, which may reduce a required storage capacity. Therefore, any implementation form using this principle falls within the protection scope of this application.

Random Time-Code-Based Pulse Modulation and Demodulation Method

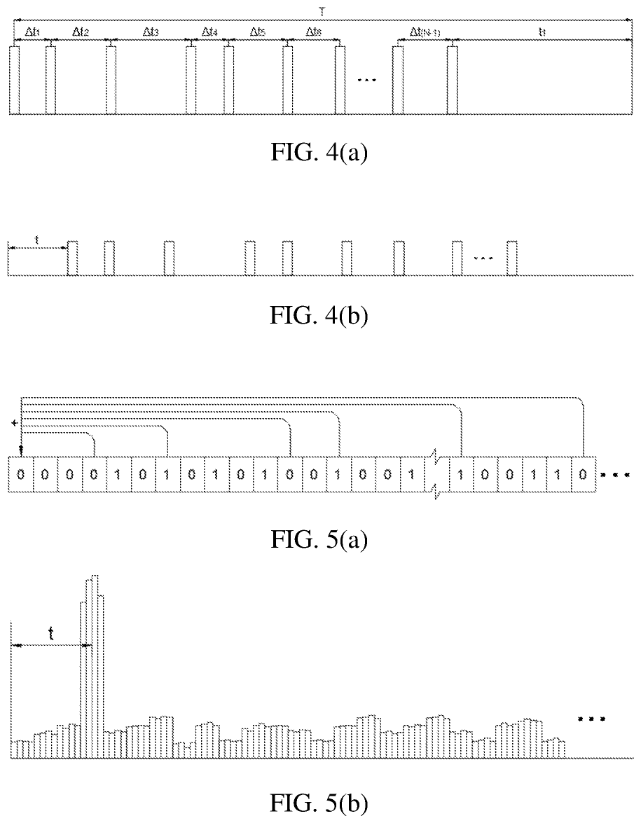

FIG. 4(a) and FIG. 4(b) are schematic diagrams of random-time-code-based pulse modulation, according to an embodiment of this application. Compared with the embodiment shown in FIG. 2(a) and FIG. 2(b), pulses in this embodiment are emitted at a preset random (pseudorandom) interval. That is, the pulses are emitted in a form of a random time code [Δt1, Δt1+Δt2, Δt1+Δt2+Δt3, . . . , Δt1+Δt2 . . . +Δt(n−1)], and Δti represents a time interval between an ith pulse and an (i+1)th pulse, where i=1,2, . . . (n−1), as shown in FIG. 4(a). If a to-be-detected target is at a position D, and a corresponding TOF is t, the collector 12 will successively receive, after the time of t, photons in the pulse train reflected by the target, as shown in FIG. 4(b). To avoid mutual interference between pulsed beams in two adjacent frame periods, a frame period T is set to T≥Σᵢ₌₁ⁿ⁻¹Δtᵢ+t₁. That is, when the target is located at a maximum measurement distance, a time required from the emitter 11 emitting the last pulse in the pulse train to the collector 12 receiving the last pulse is exactly t1. In this way, it is ensured that all pulses in a single frame period are received and not affected by pulses in an adjacent frame period. In an embodiment, assuming that the maximum measurement distance D max=150 m, and n=100000, if an average value of the random pulse period Δ̅t̅=100 ns, which is far less than 1 us in the foregoing embodiment, the frame period T is about 10 ms, and the frame rate reaches 100 fps.

FIG. 5(a) and FIG. 5(b) show a random-time-code-based consecutive single-photon counting demodulation method, according to an embodiment of this application. Same as the embodiment shown in FIG. 3(a) and FIG. 3(b), when the emitter 11 emits N pulses, the collector 12 is activated to collect a portion of photons in pulses reflected by a target. The processing circuit 13 processes and records a corresponding incident time of each incident photon, to finally form the frame-period single-photon counting timing train shown in FIG. 5(a). Each time unit of the timing train records a photon count, and a total time length of the timing train is a frame period.

In an embodiment, the collected frame-period single-photon counting timing train is stored in the internal memory. Subsequently, a histogram circuit in the processing circuit 13 draws a histogram based on the timing train Similar to the embodiment shown in FIG. 3(a) and FIG. 3(b), the histogram in this embodiment is also drawn through time-code-based consecutive single-photon counting accumulation. A difference is that the time code is a random time code. For to-be-drawn time units, accumulation, for example, sequential accumulation, is performed according to the random time code [Δt1, Δt1+Δt2, Δt1+Δt2+Δt3, . . . , Δt1+Δt2 . . . +Δt(n−1)] emitted with the pulse train. A time unit to be drawn currently is used as a start unit, photon counts in all time units subsequently spaced from the start unit by Δt1, Δt1+Δt2, Δt1+Δt2+Δt3, . . . , and Δt1+Δt2 . . . +Δt(n−1) in the timing train are sequentially accumulated with a photon count in the start unit, and an accumulated photon count is used as a value of the time unit in the histogram. For example, an accumulation manner of the first time unit in the histogram is shown by the arrow in FIG. 5(a). A histogram formed by performing time-code-based accumulation on a plurality of time units is shown in FIG. 5(b).

In an embodiment, when a time-code-based consecutive single-photon counting accumulation histogram is drawn, a length of a minimum time unit of the histogram may be integer times, such as twice of that in the frame-period single-photon counting timing train. Therefore, the amount of calculation and memory required when the histogram is drawn may be reduced.

In an embodiment, when a time-code-based consecutive single-photon counting accumulation histogram is drawn, an interval between adjacent time units, that is, a step length, may be greater than 1. For example, a time-code-based accumulation is performed at an interval of one time unit. Therefore, the amount of calculation and memory required when the histogram is drawn may also be reduced.

In an embodiment, a total time length of the histogram is [(n−1)·Δt+t1]. When accumulation is performed on time units after a time of t1, no photon count of the time units in the timing train is accumulated. A quantity of time units involved in the accumulation is gradually reduced. In practice, in an exemplary solution, it is unnecessary to draw a histogram having the same length as that of the frame period, and only a histogram in a time period from 0 to t1 needs to be drawn. Because the first wave peak will certainly appear if the target is located within the maximum measurement distance, the TOF t may be determined based on the first wave peak.

In an embodiment, a threshold may be set to search for a pulse waveform in the histogram. A value higher than the threshold is retained, and a value less than the threshold is considered as noise.

In an embodiment, a drawing order of the histogram may be changed, that is, the time units may not be drawn one by one starting from 0. For example, the drawing may be performed starting from a middle time by using a dichotomy, so that a pulse waveform may be quickly found. In conclusion, any appropriate search algorithm that can position the pulse waveform is applicable to this solution. In this embodiment, the total time length of the histogram is adaptively changed based on an execution process of the search algorithm. Once a pulse waveform is detected, the calculation will stop. Subsequently, a wave peak position may be determined by using the pulse waveform, to obtain the TOF t. Because this embodiment uses a random time code, in the accumulation histogram, a relatively large value is formed only on one or more time units of the histogram corresponding to a time t of reflection of the first pulse in the pulse train, and a case of a plurality of pulse waveforms in FIG. 3(b) does not occur. In other words, each time unit that is subsequently accumulated exactly corresponds to a time of reflection of each pulse in the pulse train only when the time t of reflection of the first pulse is used as the start unit. In this case, a probability of collecting photons is the highest, and due to the random time code, the start unit has a high degree of uniqueness. Therefore, the TOF t of the target may be calculated once a time within which a pulse waveform (wave peak) is recognized in the histogram. Generally, the total time length of the adaptive changed histogram does not exceed the maximum TOF t1, so that the calculation amount and memory consumption may be significantly reduced.

Similarly, in some embodiments, a process of drawing a frame-period single-photon counting timing train and a process of drawing a histogram based on the timing train may also be combined into one step, that is, the histogram may be directly drawn based on a photon count. The two steps may also be expanded to more than three steps. The implementation principles are the same, but the implementation forms are different, and corresponding required hardware circuits are also different. For example, an implementation form of combining two steps into one step is described in detail in the following specific processing circuit design, which may reduce a required storage capacity. Therefore, any implementation form using this principle falls within the protection scope of this application.

Dual-Random-Time-Code-Based Pulse Modulation and Demodulation Method

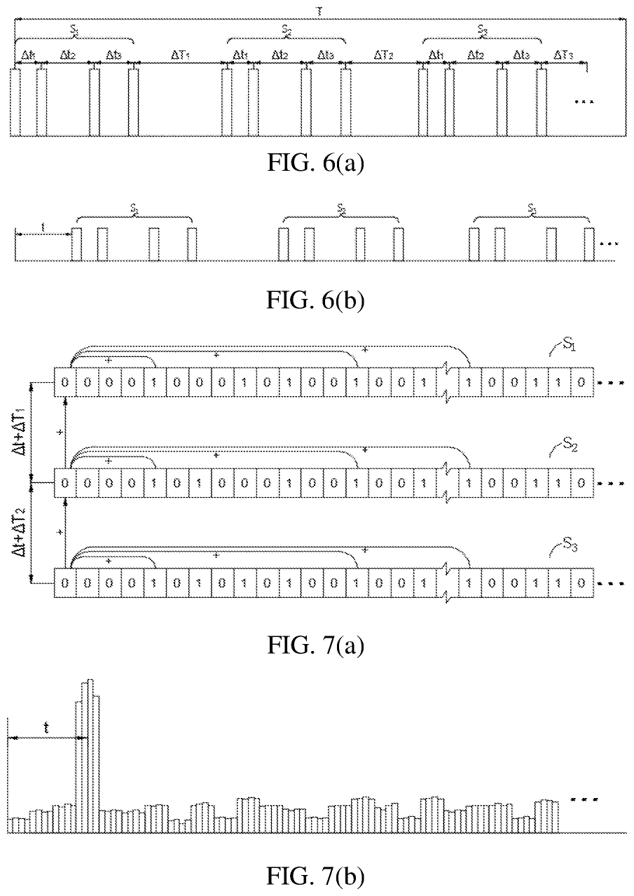

FIG. 6(a) and FIG. 6(b) are schematic diagrams of dual-random-time-code-based pulse modulation, according to an embodiment of this application. Compared with the embodiment shown in FIG. 4(a) and FIG. 4(b), pulse trains in this embodiment are emitted at a preset dual random (pseudorandom) interval. That is, all emitted pulses are divided into a plurality of pulse groups, each pulse group includes a plurality of pulses, and the pulses in the pulse group are emitted in a form of a first random time code [Δt1, Δt1+Δt2, Δt1+Δt2+Δt3, . . . , Δt1+Δt2 . . . +Δt(n−i)]. And Δti represents a time interval between an i^{th} pulse and an (i+1)^{th} pulse in each group, where i=1,2, . . . (n−1), and n is a quantity of pulses in the pulse group. The pulse groups are emitted in a form of a second random time code [ΔT1, ΔT1+ΔT2, ΔT1+ΔT2+ΔT3, . . . , ΔT1+ΔT2 . . . +ΔT(n−i)], and ΔTj represents a time interval between a j^{th} pulse group and a (j+1)^{th} pulse group, where j=1,2, . . . (N−1), and N represents a quantity of pulse groups, as shown in FIG. 6(a). N*n pulses are emitted in a single measurement in total. If a to-be-detected target is at a position D, and a corresponding TOF is t, the collector 12 will successively receive, after the time of t, photons in the pulse train reflected by the target, as shown in FIG. 6(b). To avoid mutual interference between pulsed beams in two adjacent frame periods, a frame period T is set to T≥NΣᵢ₌₁ⁿ⁻¹Δtᵢ+Σⱼ₌₁^{N-1}ΔTⱼ+t₁. That is, when the target is located at a maximum measurement distance, a time required from the emitter 11 emitting the last pulse in the pulse train to the collector 12 receiving the last pulse is exactly t1. In this way, it is ensured that all pulses in a single frame period are received and not affected by pulses in an adjacent frame period. In an embodiment, assuming that the maximum measurement distance D max=150 m, n=1000, and N=100, if an average value of an intra-group pulse period Δ̅t̅=100 ns, and an average value of an inter-group period Δ̅T̅=500 ns, which are far less than 1 us in the foregoing embodiment, the frame period T is about 10 ms, and the frame rate reaches 100 fps.

FIG. 7(a) and FIG. 7(b) show a dual-random-time-code-based consecutive single-photon counting demodulation method, according to an embodiment of this application. A difference from the embodiment shown in FIG. 5(a) and FIG. 5(b) lies in that, when the emitter 11 emits N*n pulses, the collector 12 will not perform collection within the entire time period of emission of a pulse train. Instead, the collector 12 is activated, only within a time of emission of each pulse group (considering a photon returning time difference, which may be appropriately longer than a time period of the pulse group), to collect a portion of photons in pulses reflected by a target. The processing circuit 13 processes and records a corresponding incident time of each incident photon, to finally form N pulse group period single-photon counting timing trains shown in FIG. 7(a). Each time unit of the timing train records a photon count, and a total time length of the timing train is a frame period corresponding to a pulse group.

In an embodiment, the N collected pulse group period single-photon counting timing trains are stored in the internal memory. Subsequently, a histogram circuit in the processing circuit 13 draws a histogram based on the timing trains. In practice, the histogram is drawn by fusing the conventional TCSPC and the time-code-based accumulation in the embodiment shown in FIG. 3 or FIG. 5. That is, the histogram is drawn by two steps (there is no order between the two steps, and the two steps may also be performed alternately). The first step is similar to the conventional TCSPC manner, that is, photon counts in corresponding time units among the N pulse group period single-photon counting timing trains are accumulated, as shown by the upward arrow with a plus sign in FIG. 7(a). The second step is to accumulate an overall timing train obtained in the first step, according to a first time code [Δt1, Δt1+Δt2, Δt1+Δt2+Δt3, . . . , Δt1+Δt2 . . . +Δt(n−1)] emitted with pulses in the pulse group. That is, a time unit to be accumulated currently is used as a start unit, photon counts in all time units subsequently spaced from the start unit by Δt1, Δt1+Δt2, Δt1+Δt2+Δt3, . . . , and Δt1+Δt2 . . . +Δt(n−1) in the timing train are sequentially accumulated with a photon count in the start unit, and an accumulated photon count is used as a value of the time unit in the histogram. For example, an accumulation manner of the first time unit in the histogram is shown by the horizontal plus signs in FIG. 7(a). Finally, the histogram shown in FIG. 7(b) is obtained.

In some embodiments, the time-code-based accumulation may be first performed and then the TCSPS is performed. That is, the pulse group period single-photon counting timing trains are accumulated in a form of the first time code, as shown by the horizontal plus signs in FIG. 7(a). Then, corresponding time units in N obtained accumulated timing trains are accumulated, as shown by the arrow with a plus sign in FIG. 7(a). Finally, the histogram shown in FIG. 7(b) is obtained.

Similarly, a length of a minimum time unit of the histogram may be integer times of that in the timing train. In addition, an interval between two adjacent time units in the histogram may be greater than 1, for example, a time-code-based accumulation is performed at an interval of one time unit. Therefore, the amount of calculation and memory required when the histogram is drawn may also be reduced.

Similarly, a time length of the histogram may be adaptively adjusted, and does not need to be the same as a period length of a pulse group. Generally, only a histogram in a time period from 0 to t1 needs to be drawn. Because the first wave peak will certainly occur if the target is located within the maximum measurement distance, the TOF t may be determined based on the first wave peak.

In an embodiment, a threshold may be set to search for a pulse waveform in the histogram. A value higher than the threshold is retained, and a value less than the threshold is considered as noise.

In an embodiment, a drawing order of the histogram may be changed, that is, the time units may not be drawn one by one starting from 0. For example, the drawing may be performed starting from a middle time by using a dichotomy, so that a pulse waveform may be quickly found. In conclusion, any appropriate search algorithm that can position the pulse waveform is applicable to this solution. In this embodiment, the total time length of the histogram is adaptively changed based on an execution process of the search algorithm. Once a pulse waveform is detected, the calculation will stop. Subsequently, a wave peak position may be determined by using the pulse waveform, so as to obtain the TOF t. Because this embodiment uses a random time code, in the accumulation histogram, a relatively large value is formed only on one or more time units of the histogram corresponding to a time t of reflection of the first pulse in the pulse train, and a case of a plurality of pulse waveforms in FIG. 3(b) does not occur. In other words, each time unit that is subsequently accumulated exactly corresponds to a time of reflection of each pulse in the pulse train only when the time t of reflection of the first pulse is used as the start unit. In this case, a probability of collecting photons is the highest, and due to the random time code, the start unit has a high degree of uniqueness. Therefore, the TOF t of the target may be calculated once a time within which a pulse waveform (wave peak) is recognized in the histogram. Generally, the total time length of the adaptive changed histogram does not exceed the maximum TOF t1, so that the calculation amount and memory consumption may be significantly reduced.

Compared with the random modulation and demodulation methods shown in FIG. 4(a), FIG. 4(b), FIG. 5(a), and FIG. 5(b), in the dual random modulation and demodulation method shown in FIG. 6(a), FIG. 6(b), FIG. 7(a), and FIG. 7(b), photons are not collected in the entire frame period, so that noise of ambient light may be effectively reduced, and incident photons emitted by another device when a plurality of devices coexist may be significantly reduced. Therefore, an effect of preventing interference between the plurality of machines is better.

Time Code Demodulation Processing Circuit and Processing Method

To implement the time-code-based demodulation in the foregoing embodiment, this application further provides a time-code-based demodulation processing circuit and processing method.

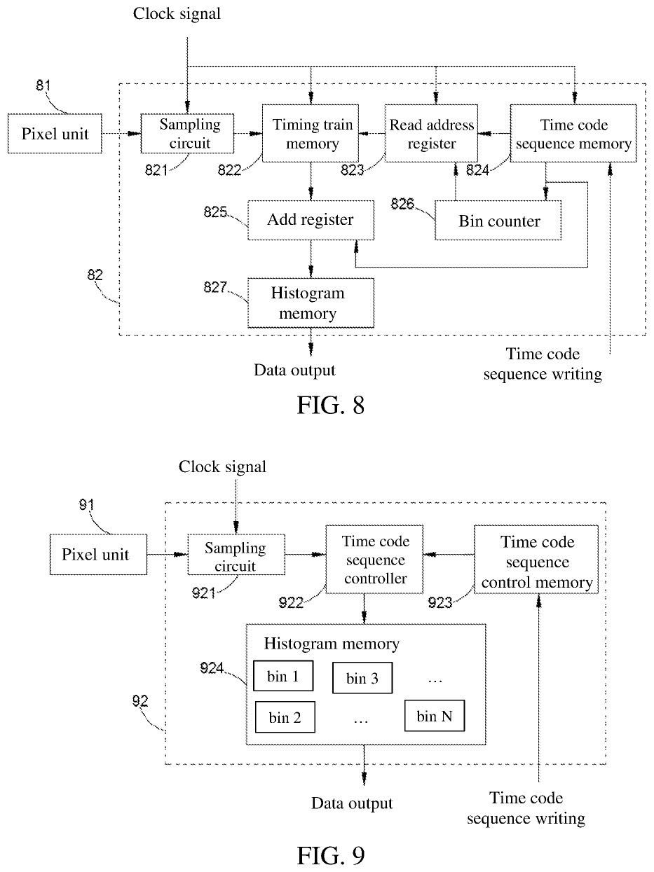

FIG. 8 shows a time-code-based demodulation processing circuit, according to an embodiment of this application. The time-code-based demodulation processing circuit 82 is connected to a pixel unit 81. The pixel unit 81 may be an SPAD pixel configured to detect photons of a reflected beam, and the processing circuit 82 processes each detected photon event to calculate a TOF of a round trip of the photons.

The time-code-based demodulation processing circuit 82 in this embodiment includes a sampling circuit 821, a timing train memory 822, a read address register 823, a time code sequence memory 824, an add register 825, a histogram time unit counter (bin counter) 826, and a histogram memory 827.

After collecting a photon signal of a reflected beam, the pixel unit 81 outputs a pulse signal representing a photon detection event. The sampling circuit 821 samples pulse signals within a period of time under the control of a clock signal (for example, 1 GHz) generated by a clock generator, to form a frame-period single-photon counting timing train. The sampling circuit 821 may be another circuit, for example, the foregoing circuit including a TDC, provided that the circuit can generate a single-photon counting timing train according to photon counting events. A sampling time interval of the sampling circuit 821 is generally not less than a pulse width, to avoid that photons cannot be sampled within a time corresponding to one pulse width. In an embodiment, when the pixel unit 81 detects a photon, the sampling circuit 821 outputs a digital signal 1. When no photon is detected, the sampling circuit 821 outputs a digital signal 0. Therefore, within a period of time, the sampling circuit 821 outputs a sequence of 0 and 1, and a sequence formed in one frame period is the frame-period single-photon counting timing train.

Frame-period single-photon counting timing trains obtained by the sampling circuit 821 through sampling are sequentially stored in the timing train memory 822 according to a memory unit address. Generally, a memory size of the timing train memory 822 varies with different sampling time lengths. For example, when a sampling time length is 1000 ms and a sampling interval 1 ns, a corresponding required memory size is 1000 bits.

The time code sequence memory 824 is configured to store a time code sequence written in advance, such as a regular time code sequence shown in FIG. 2(a) or a random time code sequence shown in FIG. 4(a).

The read address register 823 is configured to store an address of a memory unit in the timing train memory 822 that needs to be read. Under the control of a clock signal, the timing train memory 822 reads corresponding data in the address according to the address in the read address register 823 and transmits the data to the add register 825. Subsequently, the read address register 823 automatically jumps to a next address that needs to be read. For example, if a current address is x, a next address x+Δti that needs to be read is automatically jumped to based on a time code sequence stored in the time code sequence memory 824, wherein Δti is a time interval sequence value stored in the time code sequence memory 824.

The add register 825 is configured to perform an addition operation, to add data currently stored in the add register 825 and data in a corresponding storage unit that is transmitted by the timing train memory 822. After all sequences in the time code sequence memory 824 are read, the add register 825 completes calculation of one histogram time unit bin, and then writes the value into the histogram memory 827 to draw a histogram.

The bin counter 826 is configured to store a number of currently drawn bin. After all sequences in the time code sequence memory 824 are read, that is, the current bin is drawn, a pulse is sent to the bin counter 826 and the add register 825, and a number of the bin counter 826 is automatically increased by 1, to begin to draw next bin. A value of the bin is written into the histogram memory 827, and the add register 825 is zeroed out.

After each bin of the histogram is drawn, the processing circuit 82 may further calculate a TOF according to the histogram.

In the embodiment shown in FIG. 8, sampling of data and drawing of the histogram are sequentially performed in time. That is, sampling of the frame-period single-photon counting timing train is first completed and the timing train is stored into the timing train memory 822. Subsequently, data processing is performed on the timing train to obtain the histogram. To reduce a processing time to improve a frame rate, in an embodiment, a plurality of timing train memories 822 may be used. For example, two timing train memories 822 are used. After sampling of one frame of data is completed, the frame of data is stored into a first timing train memory 822. Subsequently, when a histogram is drawn by using a timing train in the first timing train memory 822, the sampling circuit 821 works at the same time, and a timing train obtained through sampling is stored into a second timing train memory 822. This process is repeated. When a histogram is drawn by using the timing train in the second timing train memory 822, the sampling circuit 821 stores a timing train obtained through sampling into the first timing train memory 822. In this way, a sampling time may be significantly reduced to improve the frame rate.

In an embodiment, based on the processing circuit shown in FIG. 8, this application further provides a time-code-based demodulation method. The method includes the following steps:

pre-storing a time code sequence into the time code sequence memory 824;

sampling, by the sampling circuit 821, photon events of a reflected beam detected by the pixel unit 81, to form a frame-period single-photon counting timing train and store the timing train into the timing train memory 822;

storing, into the read address register 823, an address of a memory unit in the timing train memory 822 that needs to be read currently, where a next address that needs to be read is automatically jumped to from the address according to the time code sequence;

reading corresponding data in the address from the timing train memory 822 according to the address in the read address register 823, and transmitting the data to the add register 825;

performing, by the add register 825, an addition operation between data currently stored in the add register 825 and the date read by the timing train memory 822, and transmitting an operation result of the addition operation to corresponding bin of the histogram memory 827 to draw a histogram; and

storing a number of currently drawn bin into the bin counter 826, and after the current bin is drawn, automatically increasing the number by 1.

In the embodiment shown in FIG. 8, a requirement on a memory is relatively high. For a technical trend of highly integrating a light sensor SPAD and a data processing circuit into a single chip, if monolithic integration is performed on the processing circuit, capacity of an on-chip memory is relatively large, which is not conducive to mass production of chips. To resolve this problem, this application provides a demodulation method of real-time histogram drawing.

FIG. 9 shows a real-time time-code-based demodulation processing circuit, according to an embodiment of this application. The time-code-based demodulation processing circuit 92 is connected to a pixel unit 91. The pixel unit 91 may be an SPAD pixel configured to detect photons of a reflected beam, and the processing circuit 92 processes each detected photon event to calculate a TOF of a round trip of the photons.

When accumulation is performed on each time unit bin in a histogram, under the premise of a time code determined, a time unit (that is, a time point of a corresponding photon event) in a timing train required when an accumulation operation is performed on each bin is known according to the time code. Based on this, a correspondence between an address of each bin and an address of a time unit in a timing train that needs to accumulated with the bin may be pre-stored. For a photon count output by a sampling circuit 921 in real time, bin corresponding to the current photon count may be learn based on the correspondence. Subsequently, the photon count is gated to enter the corresponding bin for accumulation.

The time-code-based demodulation processing circuit 92 in this embodiment includes the sampling circuit 921, a time code sequence controller 922, a time code sequence control memory 923, and a histogram memory 924.

After collecting a photon signal of the reflected beam, the pixel unit 91 outputs a pulse signal representing a photon detection event. The sampling circuit 921 samples the pulse signal under the control of a clock signal (for example, 1 GHz) generated by a clock generator, to output a sampling signal (that is, a photon count 0 or 1) to the time code sequence controller 922. The time code sequence controller 922 controls, according to the correspondence stored in the time code sequence control memory 923, the sampling signal to enter corresponding bin in the histogram memory 924 for accumulation. For example, the sampling signal may be gated in a manner such as a triple state gate or a transmission gate. The time code sequence control memory 923 stores a correspondence between a sampling signal and bin needing to be turned on. For example, the time code sequence control memory 923 includes a storage space of nxj, where n is a quantity of times bin, and j is the same as a quantity of bits of a measurement sequence of the pixel unit. Triggered by each clock, corresponding n-bit data is transmitted to the time code sequence controller 922 to control the gating of a corresponding sampling signal.

In an embodiment, based on the time-code-based demodulation processing circuit shown in FIG. 9, this application further provides a time-code-based demodulation method. The method includes the following steps:

writing a correspondence between a sampling signal and bin in the histogram memory 924 that needs to be turned on into the time code sequence control memory 923 in advance;

sampling, by the sampling circuit, a photon event of a reflected beam detected by the pixel unit 921, to form the sampling signal; and

controlling, by the time code sequence controller 922 according to the correspondence stored in the time code sequence control memory 923, the sampling signal to enter corresponding bin in the histogram memory 924 for accumulation, to draw a histogram.

The processing circuits shown in FIG. 8 and FIG. 9 are not only applicable to the demodulation methods shown in FIG. 3(a), FIG. 3(b), FIG. 5(a), and FIG. 5(b), but also applicable to the demodulation method shown in FIG. 7(a) and FIG. 7(b).

In the foregoing description, for ease of describing relationships between parts, modules are separately described. In an embodiment, a plurality of modules may be alternatively combined. For example, a timing train memory and a time code memory may be the same memory. Therefore, equivalent alternative solutions obtained through combination or separation should also fall within the protection scope of this application.

When the distance measurement system of this application is embedded in a device or hardware, a corresponding structure or component may be changed to adapt to requirements with the essence still using the distance measurement system of this application. Therefore, it falls within the protection scope of this application. The foregoing content further describes this application in detail with reference to specific or exemplary implementations, and the specific implementation of this application is limited to these descriptions. A person of ordinary skill in the art, to which this application belong, may make various replacements or variations on the described implementations without departing from the principle of this application, and the replacements or variations fall within the protection scope of this application. In the descriptions of this application, descriptions using reference terms such as “one embodiment,” “some embodiments,” “exemplary embodiment,” “example,” “specific example” or “some examples” means including specific features, structures, materials, or features described in the embodiment or example in at least one embodiment or example of this application. In this specification, the schematic expression of the above terms is not necessarily for the same embodiment or example. In addition, the described specific features, structures, materials, or features may be combined in an appropriate manner in any one or more embodiments or examples. In addition, without contradiction with each other, a person skilled in the art may combine different embodiments or examples and features of the different embodiments or examples described in this specification. Although embodiments of this application and advantages thereof have been described in detail, it should be understood that various changes, substitutions, and alterations can be made herein without departing from the scope defined by the appended claims. In addition, the scope of this application is not limited to processes, machines, manufacturing, material composition, means, methods, and steps in a specific embodiment in this specification. A person of ordinary skill in the art can easily understand and use the above disclosures, processes, machines, manufacturing, material composition, means, methods, and steps that currently exist or will be developed later and that perform substantially the same functions as the corresponding embodiments described herein or obtain substantially the same results as the embodiments described herein. Therefore, the appended claims intend to include such processes, machines, manufacturing, material compositions, means, methods, or steps within the scope thereof.

What is claimed is:

1. A time of flight (TOF)-based distance measurement system, comprising:
an emitter, configured to emit an optical signal pulse train with a time code;
a collector, configured to collect photons in the optical signal pulse train reflected by an object; and
a processing circuit, connected to the emitter and the collector, and configured to count the photons to form a frame-period single-photon counting timing train, and draw a histogram based on the time code and the frame-period single-photon counting timing train.

2. The system according to claim 1, wherein a time interval between adjacent pulse trains is less than a maximum TOF corresponding to a maximum measurement distance.

3. The system according to claim 1, wherein the collector comprises a single-photon avalanche photodiode (SPAD).

4. The system according to claim 1, wherein:
the time code is a regular time code [Δt, 2Δt, 3Δt, . . . , (n−1)Δt], wherein Δt is a pulse period, and n is a quantity of pulses included in the optical signal pulse train; and
the histogram is drawn by: using a time unit in the histogram as a start unit; accumulating photon counts in all time units subsequently spaced from the start unit by an integral quantity of Δt in the timing train and a photon count in the start unit; and using an accumulated photon count as a photon count value of the start unit.

5. The system according to claim 4, wherein the histogram is drawn starting from a middle time unit of the frame-period single-photon counting timing train, and wherein the processing circuit is configured to search for a pulse waveform, and in response to that a pulse waveform is found, to draw the histogram in a direction to an earlier time unit until no pulse waveform is found in an earlier time period spaced from the pulse waveform by Δt.

6. The system according to claim 1, wherein:
the time code is a random time code [Δt₁, Δt₁+Δt₂, Δt₁+Δt₂+Δt₃, . . . , Δt₁+Δt₂ . . . +Δt₍ₙ₋₁₎], and Δtᵢ represents a time interval between an i^{th} pulse and an (i+1)^{th} pulse, wherein i=1, 2, . . . , (n−1), and n is a quantity of pulses in the optical signal pulse train; and
the histogram is drawn by: using a time unit in the histogram as a start unit; accumulating photon counts in all time units subsequently spaced from the start unit by Δt₁, Δt₁+Δt₂, Δt₁+Δt₂+Δt₃, . . . , and Δt₁+Δt₂ . . . +Δt₍ₙ₋₁₎ in the timing train and a photon count in the start unit; and using an accumulated photon count as a photon count value of the start unit.

7. The system according to claim 6, wherein the histogram is drawn starting from a middle time unit of the frame-period single-photon counting timing train, and wherein the processing circuit is configured to search for a pulse waveform, and in response to that a pulse waveform is found, to determine a TOF according to a time corresponding to the found pulse waveform.

8. The system according to claim 4, wherein a time length of the histogram is [(n−1)·Δt+t₁], or the time length of the histogram is t₁, wherein t₁ is a maximum TOF corresponding to a maximum measurement distance.

9. The system according to claim 4, wherein a length of a minimum time unit of the histogram is integer times of that in each time unit in the frame-period single-photon counting timing train.

10. The system according to claim 4, wherein when the histogram is drawn, for the frame-period single-photon counting timing train, a time-code-based accumulation is performed at an interval of one or more time units.

11. The system according to claim 4, wherein a threshold is set to search for a pulse waveform in the histogram, wherein a value higher than the threshold is retained, and a value less than the threshold is discarded as a noise.

12. The system according to claim 4, wherein a total time length of the drawn histogram is adaptively changed based on a search algorithm execution process.

13. A time of flight (TOF)-based distance measurement method, comprising:
emitting an optical signal pulse train with a time code;
collecting photons in the optical signal pulse train reflected by an object;
counting the photons to form a frame-period single-photon counting timing train; and
drawing a histogram based on the time code and the frame-period single-photon counting timing train.

14. The method according to claim 13, wherein:
the time code is a regular time code [Δt, 2Δt, 3Δt, . . . , (n−1)Δt], wherein Δt is a pulse period, and n is a quantity of pulses included in the optical signal pulse train; and
drawing the histogram comprises: using a time unit in the histogram as a start unit; accumulating photon counts in all time units subsequently spaced from the start unit by an integral quantity of Δt in the timing train and a photon count in the start unit; and using an accumulated photon count as a photon count value of the start unit.

15. The method according to claim 14, wherein drawing the histogram comprises,
drawing the histogram starting from a middle time unit of the frame-period single-photon counting timing train, searching for a pulse waveform, and in response to that a pulse waveform is found, drawing the histogram continues in a direction to an earlier time unit until no pulse waveform is found in an earlier time period spaced from the pulse waveform by Δt.

16. The method according to claim 13, wherein:
the time code is a random time code [Δt₁, Δt₁+Δt₂, Δt₁+Δt₂+Δt₃, . . . , Δt₁+Δt₂ . . . +Δt₍ₙ₋₁₎], and Δtᵢ represents a time interval between an i^{th} pulse and an (i+1)^{th} pulse, wherein i=1,2, . . . (n−1), and n is a quantity of pulses in the optical signal pulse train; and
drawing the histogram comprises: using a time unit in the histogram as a start unit; accumulating photon counts in all time units subsequently spaced from the start unit by Δt₁, Δt₁+Δt₂, Δt₁+Δt₂+Δt₃, . . . , and Δt₁+Δt₂ . . . +Δt₍ₙ₋₁₎ in the timing train and a photon count in the start unit; and using an accumulated photon count as a photon count value of the start unit.

17. The method according to claim 16, wherein the drawing histogram is performed starting from a middle time unit of the frame-period single-photon counting timing train, searching for a pulse waveform, and in response to that a pulse waveform is found, determining a TOF according to a time corresponding to the found pulse waveform.

18. The method according to claim 14, wherein a time length of the histogram is [(n−1)·Δt+t₁], or the time length of the histogram is t₁, wherein t₁ is a maximum TOF corresponding to a maximum measurement distance.

19. The method according to claim 14, wherein a length of a minimum time unit of the histogram is integer times of that in each time unit in the frame-period single-photon counting timing train.

20. The method according to claim 14, wherein drawing the histogram, for the frame-period single-photon counting timing train, comprises performing a time-code-based accumulation at an interval of one or more time units.
